(19) United States
(12) Patent Application Publication
(10) Pub. No.: US 2010/0291361 A1
(43) Pub. Date: Nov. 18, 2010

(54) HOUSING AND METHOD OF MANUFACTURING THE SAME

(75) Inventors: JEN-HONG HSU, Tu-Cheng (TW); HE-XING FU, Shenzhen City (CN); HAI-PENG YAN, Shenzhen City (CN); HAI-LIN CHEN, Shenzhen City (CN); JIAN-WEI ZHANG, Shenzhen City (CN); YU-GUO ZHANG, Shenzhen City (CN); YONG YANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/537,412

(22) Filed: Aug. 7, 2009

(30) Foreign Application Priority Data
May 14, 2009 (CN) 200910302314.6

(51) Int. Cl. B32B 3/00; B32B 5/16; B05D 5/06

(52) U.S. Cl. 428/203; 428/204; 427/556

(57) ABSTRACT

A housing for an electronic device includes a metallic base, a chemical plating layer, a prime layer, a color coating layer, a decorative layer, and a transparent protection layer. The chemical plating layer, the prime layer, the color coating layer, the decorative layer, and the transparent protection layer are coated on the metallic base in that order. The color coating layer defines a pattern embedded in the color coating layer. The decorative layer is coated on the color coating layer and the pattern. The decorative layer has light reflective capability, and a thickness of the decorative layer is less than a depth of the pattern.

### CROSS REFERENCE STATEMENT

This application is related to a co-pending U.S. patent application, which is application [TBD] with Attorney Docket No. US27117 and entitled “HOUSING AND METHOD OF MANUFACTURING THE SAME”. In the co-pending application, the inventors are Jen-Hong Hsu, Hai-Lin Chen, Yu-Guo Zhang, Yong Yang, and Jun Zeng. The co-pending application has the same assignee as the present application.

### BACKGROUND

1. Technical Field

The present disclosure generally relates to device housings and, particularly to a housing for a portable electronic device and a method of manufacturing the housing.

2. Description of Related Art

Electronic devices such as notebook computers, MP3 players, personal digital assistants, and mobile phones are in common use. A pleasing appearance and finish, such as a metallic finish, are often important to users.

Accordingly textured patterns or stripes are often formed on the exterior housing of such devices. However, such textured patterns or stripes are often integrally formed with a color coating layer on the exterior housing of the electronic device. If the textured patterns or stripes are the same color and configuration as the color coating layer, the textured patterns or stripes may be difficult to discern, thus the appearance of the electronic device may be less appealing than is desired.

Therefore, what is needed, is a housing that overcomes the limitations described.

### BRIEF DESCRIPTION OF THE DRAWING

The components in the drawing are not necessarily drawn to scale, the emphasis instead being placed upon clearly illustrating the principles of the present disclosure.

FIG. 1 is a cross-section of a portion of an embodiment of a housing.

FIG. 2 is a flowchart of an embodiment of a method of manufacturing the housing in FIG. 1.

### DETAILED DESCRIPTION

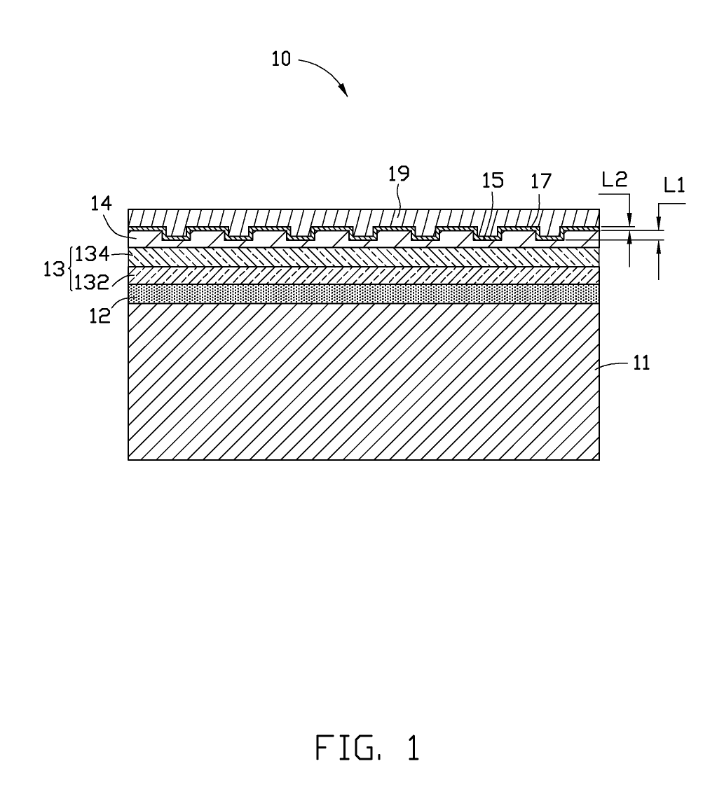

Referring to FIG. 1, an embodiment of a housing 10 includes a metallic base 11, a chemical plating layer 12, a prime layer 13, a color coating layer 14, a decorative layer 17, and a transparent protection layer 19. The chemical plating layer 12, the prime layer 13, the color coating layer 14, the decorative layer 17, and the transparent protection layer 19 are coated on the metallic base 11 in that order. The color coating layer 14 defines a pattern 15 embedded in the color coating layer 14.

The metallic base 11 may be magnesium alloy, aluminum alloy, or other metal.

The chemical plating layer 12 protects the metallic base 11 from oxidation, and improves a coating performance of the metallic base 11. The chemical plating layer 12 may be mainly phosphate.

The prime layer 13 further protects the metallic base 11 from oxidation and corrosion. In the illustrated embodiment, the prime layer 13 includes a connecting layer 132 adjacent to the chemical plating layer 12, and a shielding layer 134 coated on the connecting layer 132.

The connecting layer 132 masks surface defects of the metallic base 11, and enhances bonding between the chemical plating layer 12 and the shielding layer 134. The connecting layer 132 may include polyester resin, epoxy resin, and pigments dispersed therein. The pigments may be carbon black, exhibiting favorable absorption of laser energy. The thickness of the connecting layer 132 may be about 25 micrometers (μm) to about 50 μm.

The shielding layer 134 further masks the surface defects of the metallic base 11. The shielding layer 134 may include acrylic resin, polyester resin, epoxy resin, amino resin, acrylate copolymer, propylene glycol methyl ether acetate (PMA), butyl ester, and pigments dispersed therein. The pigments may be carbon black, exhibiting favorable absorption of laser energy. The thickness of the shielding layer 134 may be about 15 μm to about 20 μm.

The color coating layer 14 normalizes the surface of the metallic base 11. The color coating layer 14 may include acrylic resin, polyester resin, epoxy resin, amino resin, acrylate copolymer, PMA, butyl ester, and pigments dispersed therein. The pigments may be any desired color. The thickness of the color coating layer 14 may be about 15 μm to about 80 μm.

The pattern 15 may be defined in the color coating layer 14 via laser engraving. The pattern 15 embedded in the color coating layer 14 has a depth L1.

The decorative layer 17 has light reflective capability. The decorative layer 17 may include acrylic resin, polyester resin, epoxy resin, amino resin, acrylate copolymer, PMA, butyl ester, pigments, and aluminum oxide powder dispersed therein. The pigments and the aluminum oxide powder may be in a nanometer scale. The aluminum oxide powder provides metallic luster to the housing 10, and generates a light reflective effect. The pigments may be any desired color. The decorative layer 17 has a thickness L2. The thickness L2 may be about 2 μm to about 7 μm, and less than L1. Thus, the decorative layer 17 is evenly coated on the color coating layer 14 and the pattern 15.

The transparent protection layer 19 protects the decorative layer 17 and the pattern 15 from abrasion, and improves glossiness of the housing 10. The transparent protection layer 19 may include acrylic resin, polyester resin, epoxy resin, amino resin, silicon dioxide, acrylate copolymer, PMA, and butyl ester. The thickness L2 of the transparent protection layer 19 may be about 20 μm to about 80 μm.

The decorative layer 17 is evenly coated on the top surfaces of the color coating layer 14, and the side surfaces and the bottom surfaces of the pattern 15, because the thickness L2 of the decorative layer 17 is less than the depth L1 of the pattern 15. The top surfaces of the color coating layer 14, and the side surfaces and the bottom surfaces of the pattern 15 have different light reflective effects, due to differences in light input quantity and reflective angles. Thus, the pattern 15 has a visual effect different from the color coating layer 14, so that the pattern 15 is clearly defined and discernible in the color coating layer 14. In addition, the visual difference between the pattern 15 and the color coating layer 14 is enhanced by the transparent protection layer 19, rendering the pattern 15 even more clearly discernible in the color coating layer 14. Furthermore, when viewed from different aspects, the pattern 15 may show different colors, due to the light reflection of the decorative layer 17 and the light refraction of the transparent protection layer 19. The decorative layer 17 also provides metallic luster to the housing 10, giving the housing 10 a pleasing appearance.

In alternative embodiments, if the metallic base 11 has only minimal surface defects, the connecting layer 132 or the shielding layer 134 may be omitted.

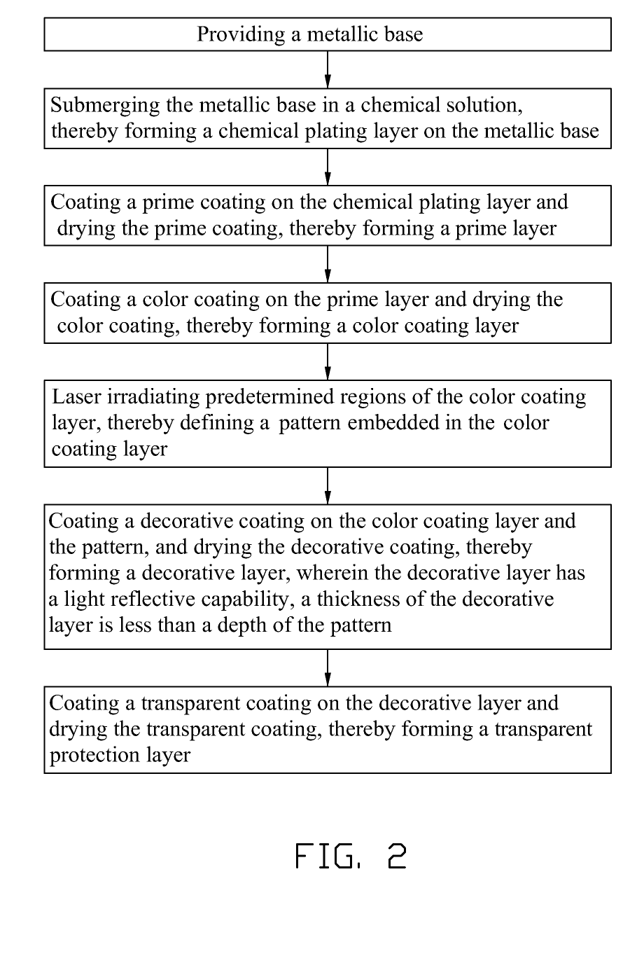

Referring to FIG. 2, an embodiment of a method of manufacturing a housing 10 is also provided.

A metallic base 11 is manufactured by casting, forging, or extrusion molding.

The metallic base 11 is submerged in a chemical solution, such as a phosphate solution, forming a chemical plating layer 12 on a surface thereof.

A prime layer 13 is coated on the chemical plating layer 12. The prime layer 13 includes a connecting layer 132 and a shielding layer 134. A connecting coating is coated on the chemical plating layer 12 and dried, thereby forming the connecting layer 132. A shielding coating is then coated on the connecting layer 132 and dried, thereby forming the shielding layer 134. The connecting coating may include polyester resin, epoxy resin, and pigments dispersed therein. The connecting coating may be coated on the chemical plating layer 12 by spray coating. A drying temperature of the connecting coating is about 150 degrees Celsius (° C.) to about 200° C. A drying time of the connecting coating is about 10 minutes to about 30 minutes. The shielding coating may include acrylic resin, polyester resin, epoxy resin, amino resin, acrylate copolymer, PMA, butyl ester, and pigments dispersed therein. The shielding coating may be coated on the connecting layer 132 by spray coating. A drying temperature of the shielding coating is about 130° C. to about 180° C. A drying time of the shielding coating is about 10 minutes to about 30 minutes.

A color coating is coated on the shielding layer 134 and dried, thereby forming a color coating layer 14. The color coating may include acrylic resin, polyester resin, epoxy resin, amino resin, acrylate copolymer, PMA, butyl ester, and pigments dispersed therein. The color coating may be coated on the shielding layer 134 by spray coating. A drying temperature of the color coating is about 50° C. to about 180° C. A drying time of the color coating is about 10 minutes to about 30 minutes.

The metallic base 11 is received in a laser engraver, and predetermined regions of the color coating layer 14 are engraved. The materials of the color coating layer 14 at the predetermined regions disintegrate due to energy of the laser, thus defining a pattern 15 in the color coating layer 14. The power of the laser is adjusted to control the depth of the pattern 15.

A decorative coating is coated on the color coating layer 14 and the pattern 15 and dried, thereby forming a decorative layer 17. The thickness of the decorative layer 17 is less than the depth of the pattern 15. The decorative coating may include acrylic resin, polyester resin, epoxy resin, amino resin, acrylate copolymer, PMA, butyl ester, pigments and aluminum oxide powder dispersed therein. The decorative coating may be coated on the color coating layer 14 and the pattern 15 by spray coating. A drying temperature of the decorative coating is about 50° C. to about 180° C. A drying time of the decorative coating is about 10 minutes to about 30 minutes.

A transparent coating is coated on the decorative layer 17 and dried, thereby forming a transparent protection layer 19. The transparent coating may include acrylic resin, polyester resin, epoxy resin, amino resin, silicon dioxide, acrylate copolymer, PMA, and butyl ester. The transparent coating may be coated on the decorative layer 17 by spray coating. A drying temperature of the transparent coating is about 50° C. to about 180° C. A drying time of the transparent coating is about 10 minutes to about 30 minutes.

Alternatively, the connecting layer 132 may be omitted, and the shielding layer 134 directly coated on the chemical plating layer 12, or the shielding layer 134 may be omitted, and the color coating layer 14 directly coated on the connecting layer 132.

In one embodiment of the method of manufacturing a housing 10, a metallic base 11 is cast of magnesium alloy, and then submerged in a phosphate solution to form a chemical plating layer 12. A connecting coating is coated on the chemical plating layer 12 and dried for about 30 minutes, at about 150° C., thus forming a connecting layer 132 about 50 μm thick. A color coating is coated on the connecting layer 132 and dried for about 15 minutes, at about 100° C., thus forming a color coating layer 14 about 15 μm thick. A laser is irradiated on the predetermined regions of the color coating layer 14, thus defining a pattern 15 in the color coating layer 14. A decorative coating is coated on the color coating layer 14 and the pattern 15, and dried for about 30 minutes, at about 50° C., thus forming a decorative layer 17. The thickness L2 of the decorative layer 17 is about 5 μm, and less than the depth L1 of the pattern 15. Finally, a transparent coating is coated on the decorative layer 17 and dried for about 10 minutes, at about 180° C., thus forming a transparent protection layer 19 about 50 μm thick.

In another embodiment of the method of manufacturing a housing 10, a metallic base 11 is forged of aluminum alloy, and then submerged in a phosphate solution to form a chemical plating layer 12. A shielding coating is coated on the chemical plating layer 12 and dried for about 10 minutes, at about 180° C., thus forming a shielding layer 134 about 15 μm thick. A color coating is coated on the shielding layer 134 and dried for about 30 minutes, at about 50° C., thus forming a color coating layer 14 about 80 μm thick. A laser is irradiated on the predetermined regions of the color coating layer 14, thus defining a pattern 15 in the color coating layer 14. A decorative coating is coated on the color coating layer 14 and the pattern 15, and dried for about 10 minutes, at about 100° C., thus forming a decorative layer 17. The thickness L2 of the decorative layer 17 is about 7 μm, and less than the depth L1 of the pattern 15. Finally, a transparent coating is coated on the decorative layer 17 and dried for about 30 minutes, at about 50° C., thus forming a transparent protection layer 19 about 80 μm thick.

In yet another embodiment of the method of manufacturing a housing 10, a metallic base 11 is cast of magnesium alloy, and then submerged in a phosphate solution to form a chemical plating layer 12. A connecting coating is coated on the chemical plating layer 12 and dried for about 10 minutes, at about 200° C., thus forming a connecting layer 132 about 25 μm thick. A shielding coating is coated on the connecting layer 132 and dried for about 30 minutes, at about 130° C., thus forming a shielding layer 134 about 20 μm thick. A color coating is coated on the shielding layer 134 and dried for about 10 minutes, at about 180° C., thus forming a color coating layer 14 about 30 μm thick. A laser is irradiated on the predetermined regions of the color coating layer 14, thus defining a pattern 15 in the color coating layer 14. A decorative coating is coated on the color coating layer 14 and the pattern 15, and dried for about 15 minutes, at about 180° C., thus forming a decorative layer 17. The thickness L2 of the decorative layer 17 is about 2 μm, and less than the depth L1 of the pattern 15. Finally, a transparent coating is coated on the decorative layer 17 and dried for about 15 minutes, at about 100° C., thus forming a transparent protection layer 19 about 20 μm thick.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A housing for an electronic device, comprising:
a metallic base;
a chemical plating layer, a prime layer, a color coating layer, a decorative layer, and a transparent protection layer coated on the metallic base in that order;
wherein the color coating layer defines a pattern embedded therein, the decorative layer is coated on the color coating layer and the pattern, the decorative layer has a light reflective capability, and a thickness of the decorative layer is less than a depth of the pattern.

2. The housing of claim 1, wherein the prime layer comprises a connecting layer adjacent to the chemical plating layer and a shielding layer coated on the connecting layer.

3. The housing of claim 2, wherein the connecting layer comprises a material selected from the group consisting of polyester resin, epoxy resin, and combination thereof; and the connecting layer also comprises pigments dispersed therein.

4. The housing of claim 2, wherein the shielding layer comprises a material selected from the group consisting of acrylic resin, polyester resin, epoxy resin, amino resin, acrylate copolymer, propylene glycol methyl ether acetate, butyl ester, and any suitable combination thereof; the shielding layer also comprises pigments dispersed therein.

5. The housing of claim 1, wherein the color coating layer comprises a material selected from the group consisting of acrylic resin, polyester resin, epoxy resin, amino resin, acrylate copolymer, propylene glycol methyl ether acetate, butyl ester, and any suitable combination thereof; the color coating layer also comprises pigments dispersed therein.

6. The housing of claim 1, wherein the decorative layer comprises a material selected from the group consisting of acrylic resin, polyester resin, epoxy resin, amino resin, acrylate copolymer, propylene glycol methyl ether acetate, butyl ester, and any suitable combination thereof; the decorative layer also comprises pigments and aluminum oxide powder dispersed therein.

7. The housing of claim 6, wherein the pigments and the aluminum oxide powder are in a nanometer scale.

8. The housing of claim 1, wherein the transparent protection layer comprises a material selected from the group consisting of acrylic resin, polyester resin, epoxy resin, amino resin, acrylate copolymer, propylene glycol methyl ether acetate, butyl ester, and any suitable combination thereof; the transparent protection layer also comprises silicon dioxide dispersed therein.

9. The housing of claim 1, wherein the pattern is defined in the decorative layer via laser engraving.

10. The housing of claim 2, wherein the thickness of the connecting layer is about 25 μm to about 50 μm, the thickness of the shielding layer is about 15 μm to about 20 μm, the thickness of the color coating layer is about 15 μm to about 80 μm, the thickness of the decorative layer is about 2 μm to about 7 μm, the thickness of the transparent protection layer is about 20 μm to about 80 μm.

11. A housing for an electronic device, comprising:
a metallic base;
a color coating layer coated on the plastic base, the color coating layer defining a pattern embedded therein; and
a decorative layer coated on the color coating layer and the pattern, the decorative layer comprising aluminum oxide powder to provide metallic luster to the housing and to generate a light reflective effect, a thickness of the decorative layer being less than a depth of the pattern.

12. The housing of claim 11, further comprising a chemical plating layer and a prime layer coated on the metallic base, and the color coating layer is coated on the prime layer.

13. The housing of claim 12, wherein the prime layer comprises a connecting layer adjacent to the chemical plating layer and a shielding layer coated on the connecting layer.

14. The housing of claim 11, further comprising a transparent protection layer coated on the decorative layer.

15. The housing of claim 11, wherein the pattern is defined in the decorative layer via laser engraving.

16. A method of manufacturing a housing for an electronic device, comprising:
providing a metallic base;
submerging the metallic base in a chemical solution, thereby forming a chemical plating layer on the metallic base;
coating a prime coating on the chemical plating layer and drying the prime coating, thereby forming a prime layer;
coating a color coating on the prime layer and drying the color coating, thereby forming a color coating layer;
laser irradiating predetermined regions of the color coating layer, thereby defining a pattern embedded in the color coating layer;
coating a decorative coating on the color coating layer and the pattern, and drying the decorative coating, thereby forming a decorative layer, wherein the decorative layer has a light reflective capability, a thickness of the decorative layer is less than a depth of the pattern; and
coating a transparent coating on the decorative layer and drying the transparent coating, thereby forming a transparent protection layer.

17. The method of manufacturing a housing of claim 16, wherein the metallic base is magnesium alloy.

18. The method of manufacturing a housing of claim 16, wherein the prime layer comprises a connecting layer adjacent to the chemical plating layer, and a shielding layer coated on the connecting layer; a connecting coating is coated on the chemical plating layer and dried, thereby forming the connecting layer, a shielding coating is then coated on the connecting layer and dried, thereby forming the shielding layer.

19. The method of manufacturing a housing of claim 18, wherein a drying temperature of the connecting coating is about 150° C. to about 200° C., a drying time of the connecting coating is about 10 minutes to about 30 minutes; and a drying temperature of the shielding coating is about 130° C. to about 180° C., and a drying time of the shielding coating is about 10 minutes to about 30 minutes.

20. The method of manufacturing a housing of claim 16, wherein the color coating, the decorative coating, or the transparent coating has a drying temperature about 50° C. to about 180° C., and a drying time about 10 minutes to about 30 minutes.
